(19) United States
(12) Patent Application Publication
(10) Pub. No.: US 2025/0111210 A1
(43) Pub. Date: Apr. 3, 2025

(54) RELATIVE POSITION BIASES IN ATTENTION NEURAL NETWORKS USING FUNCTIONAL INTERPOLATION

(71) Applicant: Google LLC, Mountain View, CA (US)

(72) Inventors: Chong You, Jersey City, NJ (US); Guru Guruganesh, Mountain View, CA (US); Joshua Timothy Ainslie, Saratoga, CA (US); Manzil Zaheer, Mountain View, CA (US); Sanjiv Kumar, Jericho, NY (US); Santiago Ontañón, Mountain View, CA (US); Shanda Li, Pittsburgh, PA (US); Venkata Sesha Pavana Srinadh Bhojanapalli, New York, NY (US); Sumit Sanghai, Sunnyvale, CA (US)

(21) Appl. No.: 18/900,531

(22) Filed: Sep. 27, 2024

Related U.S. Application Data
(60) Provisional application No. 63/586,415, filed on Sep. 29, 2023.

(51) Int. Cl. G06N 3/0475

(52) U.S. Cl. CPC G06N 3/0475

(57) ABSTRACT

Systems and methods for processing inputs using attention neural networks. In particular, one or more of the attention layers within the attention neural network compute relative position biases using functional interpolation.

### CROSS-REFERENCE TO RELATED APPLICATION

This application claims priority to U.S. Provisional Application No. 63/586,415, filed on Sep. 29, 2023. The disclosure of the prior application is considered part of and is incorporated by reference in the disclosure of this application.

### BACKGROUND

This specification relates to processing inputs using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that performs machine learning tasks on network inputs.

The machine learning tasks can be any machine learning tasks that (i) operate on a network input that is an input sequence, (ii) generate a network output that is an output sequence, or (iii) both.

In particular, the system performs the task using an attention neural network that includes one or more attention layers. One or more of the attention layers compute attention biases that modify the attention mechanism applied by the attention layer to account for the relative positions of the inputs in the sequence using functional interpolation.

The computation is referred to as using functional interpolation because the system uses an attention bias generation neural network (a learned “function”) to generate the attention biases for a given attention head of a given attention layer, allowing the system to interpolate from sequence lengths seen during training when, at inference and after training, computing attention biases for new sequence lengths not seen during training.

Particular embodiments of the subject matter described in this specification can be implemented so as to realize one or more of the following advantages.

The attention layers within many attention neural networks employ a dot-product attention mechanism which involves computing, for every given query vector, respective dot products of the query vector with all of the key vectors. This yields a quadratic dependency on the sequence length, resulting in the model consuming a significantly larger amount of computational resources when operating on or generating longer sequences than when operating on or generating shorter sequences. To account for this, many systems train attention neural networks on shorter sequences in order to keep the training of the attention neural network computationally manageable. That is, training the attention neural network on longer sequences may not be feasible because 1) training on a large amount of training data is required to attain high quality performance but 2) training on long sequences is computationally expensive, i.e., consumes a large amount of processing power and memory. Thus, training on a large amount of longer sequences would result in the training process being too computationally expensive for many training systems.

Thus, it would be desirable to train an attention neural network on shorter sequences to mitigate the impact of the quadratic complexity and keep training computationally manageable, and then use the attention neural network to process longer sequences at inference to allow the attention neural network to be deployed for tasks that require processing or generating long sequences, even though the attention neural network was not trained on these longer sequences. In other words, preventing the performance decay of attention neural networks on inputs longer than those used for training is an important challenge in extending the context length of attention neural networks for use on inference tasks that require processing long contexts when generating a given output.

However, though the attention neural network architecture has fundamentally no limits on the input sequence lengths it can process, the choice of position encoding used during training can limit the performance of these models on longer inputs at inference. That is, while making use of positional encoding to provide the neural network information about the positions of the inputs in the sequence can improve performance for shorter sequences, conventional position encoding schemes harm the ability of the neural network to generalize to longer sequences after training.

This specification, on the other hand, describes a functional relative position encoding scheme that significantly improves the generalization of the neural network to longer contexts after training, allowing the attention neural network to be trained in a computationally efficient manner while still performing well on long sequence tasks after training. The functional relative positional encoding scheme makes use of an attention bias generation neural network (a learned “function”) to generate the attention biases for a given attention head of a given attention layer, allowing the system to interpolate from sequence lengths seen during training when, at inference and after training, computing attention biases for new sequence lengths not seen during training.

In some cases, the system can implement progressive interpolation as part of the functional relative position encoding scheme, which improves the ability of the neural network to still operate accurately on shorter sequences after training while still maintaining strong generalization to longer sequences.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network system.

FIG. 2 is a flow diagram of an example process for processing an input using an attention neural network.

FIG. 3 is a flow diagram of an example process for generating a bias value for a given pair of indices.

FIG. 4 shows an example of the performance of the described techniques.

FIG. 5 shows another example of the performance of the described techniques.

Like reference numbers and designations in the various drawings indicate like elements.

### DETAILED DESCRIPTION

This specification describes a system implemented as computer programs on one or more computers in one or more locations that performs a machine learning task on a network input to generate a network output for the machine learning task.

The neural network can be configured through training to perform any kind of machine learning task, i.e., can be configured to receive any kind of input sequence and to generate any kind of score, classification, or regression output based on the input sequence.

In some situations, the neural network can be referred to as an auto-regressive neural network when the neural network auto-regressively generates an output sequence of tokens.

More specifically, the auto-regressively generated output is created by generating each particular token in the output sequence conditioned on a current input sequence that includes any tokens that precede the particular token in the output sequence, i.e., the tokens that have already been generated for any previous positions in the output sequence that precede the particular position of the particular token.

For example, the neural network can be an auto-regressive Transformer-based neural network that includes (i) a plurality of attention blocks that each apply a self-attention operation and (ii) an output subnetwork that processes an output of the last attention block to generate the score distribution.

In this example, the neural network can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv: 2203.15556, 2022; J. W. Rac, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d′Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CORR, abs/2112.11446, 2021; Colin Raffel, Noam Shazeer, Adam Roberts, Katherine Lec, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Lc. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neclakantan, Pranav Shyam, Girish Sastry, Amanda Askell, et al. Language models are few-shot learners. arXiv preprint arXiv: 2005.14165, 2020.

Generally, to apply the self-attention operation, each attention block uses one or more attention heads. Each attention head generates a set of queries, a set of keys, and a set of values, and then applies any of a variety of variants of query-key-value (QKV) attention, e.g., a dot product attention function or a scaled dot product attention function, using the queries, keys, and values to generate an output. Each query, key, value can be a vector that includes one or more vector elements. When there are multiple attention heads, the attention block then combines the outputs of the multiple attention heads, e.g., by concatenating the outputs and, optionally, processing the concatenated outputs through a linear layer.

Some examples of machine learning tasks that a neural network when implemented using one of the architectures described above or other known architectures can be configured to perform follow.

In some cases, the neural network is a neural network that is configured to perform an image processing task, i.e., receive an input image and to process the input image to generate a network output for the input image. For example, the task may be image classification and the output generated by the neural network for a given image may be scores for each of a set of object categories, with each score representing an estimated likelihood that the image contains an image of an object belonging to the category. As another example, the task can be image embedding generation and the output generated by the neural network can be a numeric embedding of the input image. As yet another example, the task can be object detection and the output generated by the neural network can identify locations in the input image at which particular types of objects are depicted. As yet another example, the task can be image segmentation and the output generated by the neural network can assign each pixel of the input image to a category from a set of categories. In some other cases, the neural network is a neural network that is configured to perform an image generation task, where the input is a conditioning input and the output is a sequence of intensity value inputs for the pixels of an image.

As one example, the task may be a neural machine translation task. For example, if the input to the neural network is a sequence of text, e.g., a sequence of words, phrases, characters, or word pieces, in one language, the output generated by the neural network may be a translation of the sequence of text into another language, i.e., a sequence of text in the other language that is a translation of the input sequence of text. The vocabulary for the input tokens may be words, wordpieces or characters of the first language, and the vocabulary for the output tokens may be words, wordpieces or characters of the other language. As a particular example, the task may be a multi-lingual machine translation task, where a single neural network is configured to translate between multiple different source language-target language pairs. In this example, the source language text may be augmented with an identifier that indicates the target language into which the neural network should translate the source language text.

Some implementations may be used for automatic code generation. For example, the input tokens may represent words, wordpieces or characters in a first natural language and the output tokens may represent instructions in a computer programming or markup language, or instructions for controlling an application program to perform a task, e.g., build a data item such as an image or web page.

As another example, the task may be an audio processing task. For example, if the input to the neural network is a sequence representing a spoken utterance, the output generated by the neural network may be a score for each of a set of pieces of text, each score representing an estimated likelihood that the piece of text is the correct transcript for the utterance. As another example, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can be a classification of the spoken utterance into one of a plurality of categories, for example an identity of the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram, a waveform, or other data defining audio of the text being spoken in the natural language.

As another example, the task can be a health prediction task, where the input is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient. Such electronic health data may, for example, comprise one or more sequences of physiological data taken from a patient, with the output being a corresponding prediction that relates to those sequences of data. Examples of physiological data and a corresponding prediction include: blood glucose measurements, with the prediction being a predicted future blood glucose measurement or the prediction of a hyper- or hypo-glycemic event; a heart rate, with the prediction being the presence or absence of a heart condition, or a future cardiac event; blood pressure measurements, with the prediction being the risk of a future heart condition; or the like.

As another example, the task can be a text generation task, where the input is a sequence of text, and the output is another sequence of text, e.g., a completion of the input sequence of text, a response to a question posed in the input sequence, or a sequence of text that is about a topic specified by the first sequence of text. As another example, the input to the text generation task can be an input other than text, e.g., an image, and the output sequence can be text that describes the input.

In some implementations the input sequence represents data to be compressed, e.g., image data, text data, audio data, or any other type of data; and the output sequence a compressed version of the data. The input and output tokens may each comprise any representation of the data to be compressed/compressed data, e.g., symbols or embeddings generated/decoded by a respective neural network.

As another example, the task can be an agent control task, where the input is a sequence of observations or other data characterizing states of an environment and the output defines an action to be performed by the agent in response to the most recent data in the sequence. The agent can be, e.g., a real-world or simulated robot, a control system for an industrial facility, or a control system that controls a different kind of agent. The observations may comprise sensor data captured by sensors associated with (e.g., part of) the agent, for example visual data, LIDAR data, sonar data, agent configuration data (e.g., joint angles), agent orientation data, or the like.

In some implementations, the environment is a real-world environment, the agent is a mechanical (or electro-mechanical) agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate or manipulate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example, in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example captured by a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements, e.g., steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example, in the case of an autonomous or semi-autonomous land or air or sea vehicle the control signals may define actions to control navigation, e.g., steering, and movement e.g., braking and/or acceleration of the vehicle.

In some implementations the environment is a simulation of the above-described real-world environment, and the agent is implemented as one or more computers interacting with the simulated environment. For example, a system implementing the neural network may be used to select actions in the simulated environment during training or evaluation of the system and, after training, or evaluation, or both, are complete, the action selection policy may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example, the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

In some implementations, as described above, the agent may not include a human being (e.g., it is a robot). Conversely, in some implementations the agent comprises a human user of a digital assistant such as a smart speaker, smart display, or other device. Then the information defining the task can be obtained from the digital assistant, and the digital assistant can be used to instruct the user based on the task.

For example, a system implementing the neural network may output to the human user, via the digital assistant, instructions for actions for the user to perform at each of a plurality of time steps. The instructions may for example be generated in the form of natural language (transmitted as sound and/or text on a screen) based on actions chosen by the system. The system chooses the actions such that they contribute to performing a task. A monitoring system (e.g., a video camera system) may be provided for monitoring the action (if any) which the user actually performs at each time step, in case (e.g., due to human error) it is different from the action which the system instructed the user to perform. Using the monitoring system the system can determine whether the task has been completed. The system may identify actions which the user performs incorrectly with more than a certain probability. If so, when the system instructs the user to perform such an identified action, the system may warn the user to be careful. Alternatively or additionally, the system may learn not to instruct the user to perform the identified actions, i.e., ones which the user is likely to perform incorrectly.

More generally, the digital assistant instructing the user may comprise receiving, at the digital assistant, a request from the user for assistance and determining, in response to the request, a series of tasks for the user to perform, e.g., steps or sub-tasks of an overall task. Then for one or more tasks of the series of tasks, e.g., for each task, e.g., until a final task of the series the digital assistant can be used to output to the user an indication of the task, e.g., step or sub-task, to be performed. This may be done using natural language, e.g., on a display and/or using a speech synthesis subsystem of the digital assistant. Visual, e.g., video, and/or audio observations of the user performing the task may be captured, e.g., using the digital assistant. A system as described above may then be used to determine whether the user has successfully achieved the task, e.g., step or sub-task, i.e., from the answer as previously described. If there are further tasks to be completed the digital assistant may then, in response, progress to the next task (if any) of the series of tasks, e.g., by outputting an indication of the next task to be performed. In this way the user may be led step-by-step through a series of tasks to perform an overall task. During the training of the neural network, training rewards may be generated, e.g., from video data representing examples of the overall task (if corpuses of such data are available) or from a simulation of the overall task.

In a further aspect there is provided a digital assistant device including a system as described above. The digital assistant can also include a user interface to enable a user to request assistance and to output information. In implementations this is a natural language user interface and may comprise a keyboard, voice input-output subsystem, and/or a display. The digital assistant can further include an assistance subsystem configured to determine, in response to the request, a series of tasks for the user to perform. In implementations this may comprise a generative (large) language model, in particular for dialog, e.g., a conversation agent such as Sparrow (Glaese et al. arXiv: 2209.14375) or Chinchilla (Hoffmann et al. arXiv: 2203.15556). The digital assistant can have an observation capture subsystem to capture visual and/or audio observations of the user performing a task; and an interface for the above-described language model neural network (which may be implemented locally or remotely). The digital assistant can also have an assistance control subsystem configured to assist the user. The assistance control subsystem can be configured to perform the steps described above, for one or more tasks, e.g., of a series of tasks, e.g., until a final task of the series. More particularly the assistance control subsystem and output to the user an indication of the task to be performed, capture, using the observation capture subsystem, visual or audio observations of the user performing the task, determine from the above-described answer whether the user has successfully achieved the task. In response the digital assistant can progress to a next task of the series of tasks and/or control the digital assistant, e.g., to stop capturing observations.

As another example, the task can be a genomics task, where the input is a sequence representing a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some cases, the machine learning task is a combination of multiple individual machine learning tasks, i.e., the system is configured to perform multiple different individual machine learning tasks, e.g., two or more of the machine learning tasks mentioned above. For example, the system can be configured to perform multiple individual natural language understanding tasks, with the network input including an identifier for the individual natural language understanding task to be performed on the network input.

In some cases, the machine learning task is a multi-modal processing task that requires processing multi-modal data. In general, multi-modal data is a combination of two or more different types of data, e.g., two or more of audio data, image data, text data, or graph data. As one example the multi-modal data may comprise audio-visual data, comprising a combination of pixels of an image or of video and audio data representing values of a digitized audio waveform. As another example the multi-modal data may comprise a combination of i) text data representing text in a natural language and ii) pixels of an image or of video or audio data representing values of an audio waveform. Optionally, but not necessarily, the different types of data may represent the same or overlapping objects using the different modalities (types), and when processing multi-modal data the data may be mapped into a common embedding space.

As a particular example, the task is a multi-modal processing task that requires processing both text and image inputs, so that the neural network includes both a computer vision neural network and a text processing neural network. That is, the target output to be generated by the computer vision neural network for a given image depends on one or more outputs generated by the text processing neural network for one or more corresponding text inputs (and vice versa). Examples of such tasks include open-vocabulary image classification, open-vocabulary object detection, image captioning, text-based image search, image-based retrieval, and so on.

More generally, the multi-modal processing task may correspond to any of the tasks previously described for any of the types of data making up the multi-modal combination. For example, an accuracy of the previously described tasks may be increased when the task is applied to multi-modal data combining the data for which the task has been previously described and another type of data. For example, detection or classification of an object or event may be improved when data of multiple different types (modalities) is processed.

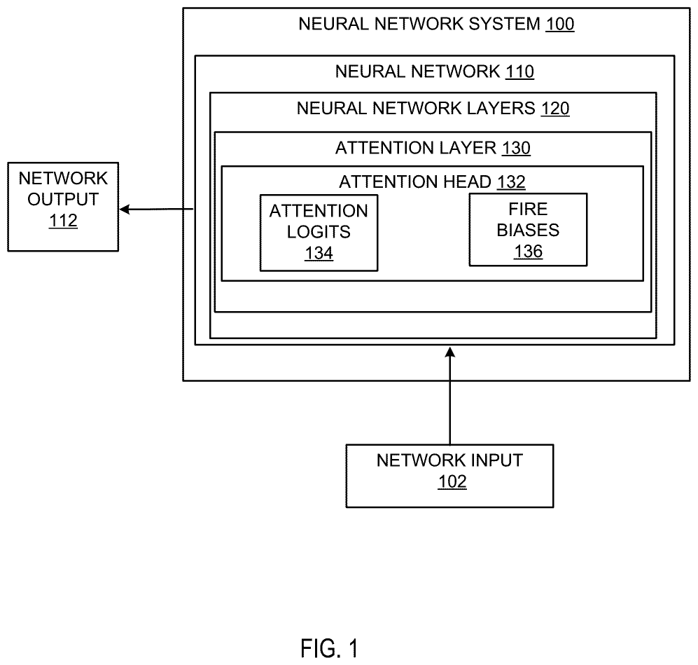

FIG. 1 shows an example neural network system 100. The neural network system 100 is an example of a system implemented as computer programs on one or more computers in one or more locations, in which the systems, components, and techniques described below can be implemented.

The system 100 is a system that processes a network input 102 using an attention neural network 110 to generate a network output 112 for a machine learning task, e.g., one of the tasks described above.

In particular, as described above, the machine learning task can be any machine learning task that (i) operates on a network input 102 that is an input sequence of tokens, (ii) generates a network output 112 that is an output sequence of tokens, or (iii) both. More generally, as described above, the task to be performed by the neural network 110 on a given network input 102 can be specified by a “prompt” or other instruction that is included as part of the network input 102.

A token, as used in this specification, is an ordered collection of numerical values, e.g., a vector of floating point or other numerical values, that represents a given input or output.

For example, tokens can be generated by processing the corresponding inputs or outputs through an appropriate embedding layer or embedding neural network or can be the outputs of intermediate layers of the neural network 110.

Generally, the neural network layers 120 within the attention neural network 110 include one or more initial neural network layers, e.g., an embedding layer and optionally one or more additional layers, a sequence of attention blocks 130, and one or more output layers that process the output of the last attention block 130 in the sequence as part of generating the network output 112.

As one example, when the network input 102 is an input sequence, the attention neural network 110 can process the network input 102 in a single forward pass to generate the network output 112.

As another example, when the network input 102 is an input sequence or has been mapped to an input sequence by an encoder neural network and the network output 112 is also a sequence that includes multiple elements, the attention neural network 110 can operate auto-regressively and generate the network output 112 over multiple time steps. At each time step, the attention neural network 110 processes the network input 102 (or a sequence generated from the network input 102) and the already generated elements of the output sequence to generate the next one or more elements of the output sequence.

As yet another example, when the network input 102 is an input sequence and the network output 112 is also a sequence that includes multiple elements, the attention neural network 110 can include an encoder neural network that generates a respective encoded representation of each of the inputs in the input sequence in a single forward pass and a decoder neural network that operates auto-regressively and generates the network output 112 over multiple time steps. At each time step, the decoder neural network processes the encoded representations and the already generated elements of the output sequence to generate the next one or more elements of the output sequence. In these examples, some of the attention blocks 130 are in the encoder neural network while others are in the decoder neural network.

Each attention block 130 operates on a respective input sequence that includes a respective input vector at each of one or more positions.

Moreover, each of the blocks 130 includes an attention mechanism layer (“attention layer”) and, in some implementations, a feed-forward layer.

The attention mechanism layer receives the input sequence for the layer and applies an attention mechanism on the input sequence for the layer to generate an attended input sequence.

The attention mechanism applied by the attention mechanism layer depends on the configuration of the attention neural network.

As one example, as described above, when the network input 102 is an input sequence, the attention neural network 110 can process the network input 102 in a single forward pass to generate the network output 112. In this example, the attention mechanism layers apply non-causal self-attention.

As another example, as described above, when the network input 102 is an input sequence or has been mapped to an input sequence by an encoder neural network and the network output 112 is also a sequence that includes multiple elements, the attention neural network 110 can operate auto-regressively and generate the network output 112 over multiple time steps. At each time step, the attention neural network 110 processes the network input 102 (or the sequence generated from the network input) and the already generated elements of the output sequence to generate the next one or more elements of the output sequence. In this example, the attention mechanism applies causal self-attention.

As another example, when the network input 102 is an input sequence and some of the attention blocks are in the encoder portion of the attention neural network 110 and other attention blocks are in the decoder portion of the attention neural network 110, the attention neural network 110 can process the network input 102 using the encoder portion in a single forward pass to generate an encoded representation of the input. In this example, the attention mechanism layers within the encoder portion apply non-causal self-attention. The decoder portion of the attention neural network 110 can then operate auto-regressively and generate the network output 112 over multiple time steps. At each time step, the attention neural network 110 processes the already generated elements of the output sequence to generate the next one or more elements of the output sequence conditioned on the encoded representation. In this example, some of the attention mechanism layers in the decoder apply causal self-attention while others of the attention mechanism layers in the decoder apply cross-attention between the already generated elements of the output sequence and the encoded representation.

Generally, to apply the attention mechanism, each attention mechanism layer uses one or more attention heads 132.

Each attention head 132 generates a set of queries, a set of keys, and a set of values, and then applies any of a variety of variants of query-key-value (QKV) attention, e.g., a dot product attention function or a scaled dot product attention function, using the queries, keys, and values. To apply the attention, the attention head 132 uses the queries and keys to generate initial attention logits 134. Each query, key, value can be a vector that includes one or more vector elements. For self-attention, the queries, keys, and values are each generated by applying a respective transformation to the input sequence to the attention head 132. For cross-attention, the queries are generated by applying a transformation to the input sequence to the attention head 132 while the keys and values are generated by applying respective transformations to a context (or “memory”) input for the layer, e.g., to the encoded representation of some or all of the network input.

The attention head 132 then uses the initial attention logits 132 to generate the output of the attention head 132. For example, the attention head 132 can map the initial attention logits to attention weights, and then apply the attention weights to at least the key for the last position in the input sequence to generate the output of the attention head 132.

When there are multiple attention heads, the attention mechanism layer then combines the outputs of the multiple attention heads, e.g., by concatenating the outputs and, optionally, processing the concatenated outputs through a linear layer.

Generally, however, as part of applying the attention mechanism, the attention heads 132 of some or all of the attention blocks 130 compute attention biases 136 using functional interpolation. These are also referred to as functional interpolation for relative encoding (fire) biases 136.

In particular, the attention head 132 generates attention biases 136 that encode the relative positions of the inputs in the input sequence to the attention head 132. More specifically, the attention biases 136 are generated using a corresponding attention bias generation neural network for the attention head 132. The attention bias generation neural network has parameter values that are learned during the training of the attention neural network.

The attention head 132 then combines the initial attention logits 134 and the biases 136 to generate final attention logits and uses the final attention logits in place of the initial attention logits 134 when generating the output of the attention head 132.

As will be described below, the inclusion of the biases 136 gives the attention mechanism information about the relative positions within the input sequence of the inputs used to generate the queries, keys, and values that are operated on by the attention mechanism. Because the biases 136 are generated using functional interpolation, these biases allow the attention mechanism to effectively generalize to longer input sequences after the training of the neural network 110.

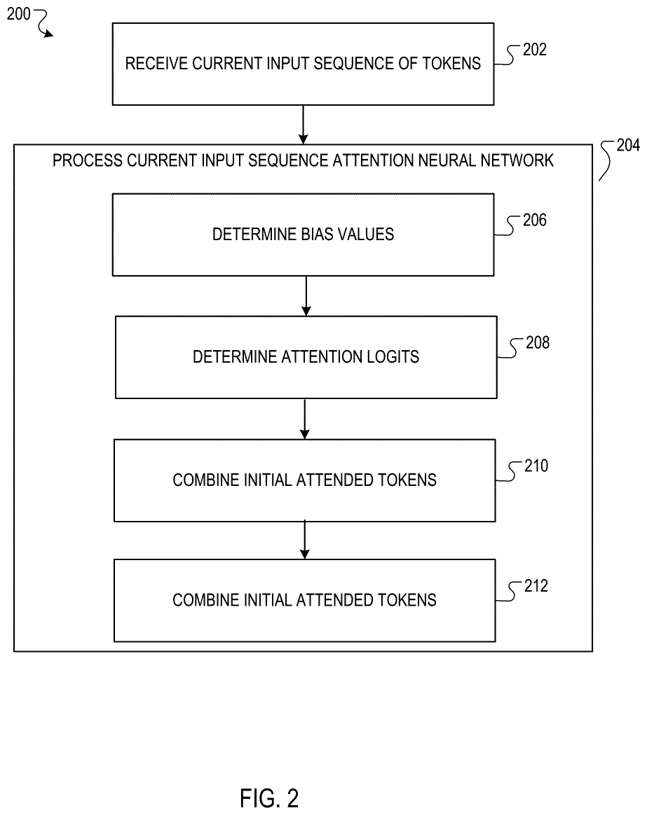

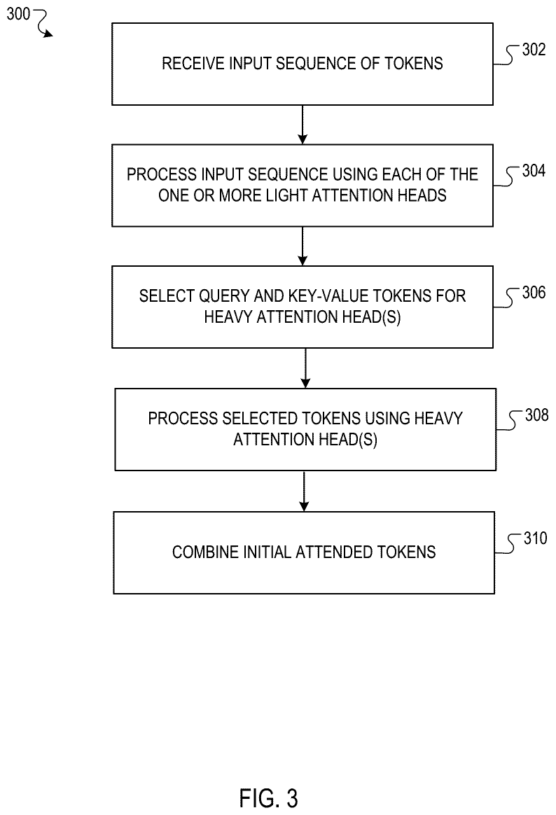

Generating the biases 136 will be described below with reference to FIGS. 2 and 3.

As used in this specification, the term “learned” means that an operation or a value has been adjusted during the training of the attention neural network.

Thus, the attention bias generation neural network having parameter values that are learned during the training of the attention neural network means that the attention bias generation neural network has been trained jointly with the attention neural network 110.

FIG. 2 is a flow diagram of an example process 200 for processing an input using an attention neural network. For convenience, the process 200 will be described as being performed by a system of one or more computers located in one or more locations. For example, a neural network system, e.g., neural network system 100 of FIG. 1, appropriately programmed in accordance with this specification, can perform the process 200.

The system can perform the process 200 when performing auto-regressive inference using the attention neural network, when performing non-auto-regressive inference using the attention neural network, or during the training of the attention neural network.

The system receives a current input sequence having a respective input token at each of a plurality of input positions each having a respective index (step 202).

For example, when performing auto-regressive inference using the attention neural network, the current input sequence includes the already-generated elements of the output sequence and, in some cases, the network input or a representation of the network input, e.g., as generated by an encoder neural network. In these cases, the attention neural network can either process the entire current input sequence or can process only the last input token in the current input sequence while retrieving keys and values for the input tokens at earlier positions in the current input sequence from a memory (a “KV cache”).

When performing non-auto-regressive inference or during training of the neural network to perform non-auto-regressive inference, the current input sequence is the network input or a representation of the network input.

During training of the attention neural network on a given training example that includes a training output sequence to perform auto-regressive inference, the current input sequence includes the training output sequence.

The system processes the current input sequence using an attention neural network having a plurality of attention layers to generate an output for the current input sequence (step 204).

For example, during auto-regressive inference, the output can indicate the next token to follow the last input token in the current input sequence.

During training or during non-auto-regressive inference, the network output can be a different type of network output.

For example, during training of the attention neural network on a given training example that includes a training output sequence to perform auto-regressive inference the network output can include a respective probability distribution for some or all of the positions in the current input sequence.

As another example, during non-auto-regressive inference, the network output can be a classification or a regression output.

As described above, each attention layer includes one or more attention heads. As part of the processing, the system performs steps 206-212 for each attention head of each of one or more of the attention layers, i.e., for each attention layer that generates attention biases using functional interpolation.

The system determines a set of bias values for the attention head (step 206).

The set of bias values includes a respective bias value for each of a plurality of pairs of indices, where each pair of indices includes a respective first index, i.e., a respective index for one of the plurality of input positions, and a respective second index, i.e., a respective index for another one of the plurality of input positions.

For example, during auto-regressive inference, the attention layer applies causal attention and the respective second index in each of the plurality of pairs is an index of the last token in the current input sequence. That is, when the attention is “causal” and generation is auto-regressive, the attention head only needs to update the last token in the current input sequence.

During non-auto-regressive inference or when the attention layer is part of an encoder, the attention layer applies bi-directional attention and the plurality of pairs includes each possible pair of input indices in the current input sequence.

During training of the neural network to perform auto-regressive inference, the attention layer still applies causal attention, but the plurality of pairs includes, for each particular token after the first token in the current input sequence, each possible pair of input indices in the current input sequence that includes the index of the particular token and the index of a token that is not after the particular token in the current input sequence.

Generally, the respective bias value for each of the plurality of pairs of indices is generated by processing an input for the pair of indices that is based on (i) the respective first index in the pair and (ii) the respective second index in the pair using a corresponding attention bias generation neural network for the attention head.

For example, the system can directly use the attention bias generation neural network to process the input to generate the bias value.

As another example, the system can have pre-computed the bias values for the pairs by processing inputs using the neural network and can then access the pre-computed (“cached”) values from memory to use them when computing bias values. For example, after the corresponding attention bias generation neural network has been trained, the system can pre-compute the bias values for a set of possible pairs of indices, e.g., selected based on the length of input sequences expected to be processed after training, and then store the pre-computed values in memory for use when computing bias values for future inputs.

Processing an input to generate a bias value for a given pair of indices is described in more detail below with reference to FIG. 3.

The system determines a set of initial attention logits for the attention head that includes a respective attention logit for each of the pairs of indices from at least (i) a respective query for the attention head for the last token in the current input sequence and (ii) respective keys for the attention head for the tokens in the current input sequence (step 208).

That is, during auto-regressive inference, the system can generate the respective logit for each of the pairs of indices by determining a product between the respective query for the attention head for the last token in the current input sequence and the respective keys for the attention head for the tokens in the current input sequence.

During non-auto-regressive inference or when the attention layer is part of an encoder, the system can generate the respective logit for each of the pairs of indices by determining a product between a matrix that includes the respective queries for the attention head for the tokens in the current input sequence and a matrix of the respective keys for the attention head for the tokens in the current input sequence.

During training of the neural network to perform auto-regressive inference, the system can generate the respective logit for each of the pairs of indices by determining a product between a matrix that includes the respective queries for the attention head for the tokens in the current input sequence and a matrix of the respective keys for the attention head for the tokens in the current input sequence and then applying a mask to the product to mask out, e.g., by setting to negative infinity, the logits for pairs that are not included in the plurality of pairs of indices. Alternatively, the system can instead perform this masking to the final attention logits described below rather than to the initial attention logits.

The system generates final attention logits for the attention head (step 210).

As part of generating the final attention logits, the system combines the set of initial attention logits with the set of bias values. For example, the system can sum the initial attention logits with the set of bias values or can subtract the bias values from the initial attention logits.

Optionally, the system can also apply other operations to the combination of the set of initial attention logits with the set of bias values to generate the final attention logits. For example, the system can divide the combination by a scaling factor.

The system applies the final attention logits to respective values for the attention head for the tokens in the current input sequence to generate an attention head output (step 212).

For example, the system can apply a softmax function to the final attention logits to generate a set of attention weights and then multiply a matrix of the attention weights by a matrix of the respective values to generate the attention head output.

When the attention layer includes multiple attention heads, the attention layer can combine the attention head outputs for the multiple attention heads to generate a final output for the attention layer. For example, the attention layer can concatenate the attention head outputs and apply a linear transformation to the concatenation to generate the attention head outputs.

FIG. 3 is a flow diagram of an example process 300 for generating a bias value for a pair of indices for an attention head of an attention layer. For convenience, the process 300 will be described as being performed by a system of one or more computers located in one or more locations. For example, a neural network system, e.g., neural network system 100 of FIG. 1, appropriately programmed in accordance with this specification, can perform the process 300.

The system can perform the process 300 for each attention head of each attention layer that uses functional interpolation to generate attention biases.

As described above, during training, the system can perform the process 300 for each batch of training inputs.

After training, in some implementations, the system can perform the process 300 each time a new input or batch of new inputs is received. In some other implementations, the system can perform the process 300 for multiple possible pairs of positions after training is completed to generate the bias values for the pairs and then store the generated bias values in memory. When new inputs are received, the system can retrieve the generated bias values from the memory for use in processing the new inputs.

The system identifies the respective first index in the pair and the respective second index in the pair of indices (step 302).

The system generates an input for the pair of indices (step 304). Generally, the input is based on (i) the respective first index j in the pair and (ii) the respective second index i in the pair.

In some implementations, the input is the difference between the respective second index and the respective first index divided by the respective second index. That is, the input can satisfy:

$$\frac{i - j}{i} .$$

That is, rather than using the raw distance between the two indices as the input, the system normalizes the distance by the second index.

Generally, using the raw distance as an input can suffer from generalization issues when the inputs (the relative distances) are outside the training domain of the neural network. Normalizing the distance by the second index addresses this challenge. For example, when performing causal attention, the second index i is the index of the query, and the first index is the index i of the key and the relative distance will always be between 0 and i. Therefore, normalizing by i ensures that the distance is constrained to be in [0,1] regardless of the sequence length.

In particular, with increasingly longer sequence lengths, the positional inputs will form progressively finer grids, interpolating the positional encoding function on [0, 1]. Hence, this technique aligns the inference domain with the training domain for any sequence lengths, leading to better length generalization through functional interpolation.

In some cases, attention biases can change more rapidly for the local tokens, i.e., tokens that are close to one another in the sequence than for the distant tokens, i.e., tokens that are far from one another in the sequence. In some implementations, to account for this, the system can incorporate a transformation function y into the computation of the input. Thus, in some implementations, the input is a) the difference between (i) the output of the transformation function applied to the respective second index and (ii) the output of the transformation function applied to the respective first index divided by b) the output of the transformation function applied to the respective second index.

In other words, the input can satisfy:

$$\frac{ψ ( i - j )}{ψ ( i )} .$$

In particular, the system can use a transformation function y that amplifies the differences among local positions, i.e., relative to far apart positions.

For example, the transformation function can be a monotonically increasing transformation with a monotonically decreasing slope, ensuring that differences between local positions, i.e., that have small raw distances with the second index, are amplified more than differences between distant positions, i.e., that have large raw distances with the second index.

As one example of this, the transformation function y can satisfy:

$$ψ ( x ) = log ( cx + 1 ) .$$

where c is a fixed value after training. In some examples, the transformation function can have one or more parameters that are learned jointly with the training of the attention neural network. For example, in the above example, the value of c can be learned jointly with the training of the attention neural network. When the value of c is not learned jointly, the value can be determined as part of a hyperparameter search or can be received as input by the system.

While the above progressive interpolation technique offers robust length generalization capabilities, in some cases, making use of the above interpolation technique can cause a marginal degradation in model performance for shorter sequences. For example, this can occur because the actual relative distances are important in positional encodings of short sequences, while the normalization in progressive interpolation obfuscates this information. To address this, the system can optionally make use of an adaptive thresholding mechanism, activating the progressive interpolation technique only for larger query position indices, i.e., long contexts.

For example, the input can be a) the difference between (i) the output of the transformation function applied to the respective second index and (ii) the output of the transformation function applied to the respective first index divided by b) the output of the transformation function applied to a maximum of iii) a scalar value L or iv) the respective second index. In other words, the input can satisfy:

$$\frac{ψ ( i - j )}{ψ ( max \{ L , i \} )} .$$

Thus, the scalar value L causes the system to only apply progressive interpolation when i>L. For short sequences with less than L tokens, the system uses ψ(L) to normalize the relative distance.

In some cases, rather than being predetermined, the scalar value L can be learned jointly during the training of the attention neural network. This allows the system to learn the value at which normalizing by the second index i begins to improve the quality of the outputs generated by the attention neural network.

The system processes the input using a corresponding attention bias generation neural network for the attention head to generate the bias value for the pair (step 306).

The corresponding attention bias generation neural network can generally have any appropriate neural network architecture. As one example, the neural network can be a multi-layer perceptron (MLP). Other architectures are also possible, e.g., Transformer neural networks, convolutional neural networks, and so on.

In some implementations, the system maintains a different attention bias generation neural network for each attention head of each attention layer that uses functional interpolation.

In some other implementations, the system maintains a single neural network that is configured to output respective bias values for each of the attention heads. That is, a shared neural network processes the input for the pair to generate (different) bias values for the attention heads of the attention layer(s).

In yet other implementations, the attention heads of each attention layer share the same bias values. In these implementations, a shared neural network for the attention layer processes the input for the pair to generate a single bias value for the pair that is shared across the attention heads of the attention layer.

In yet other implementations, the attention heads of all of the attention layers share the same bias values. In these implementations, a shared neural network processes the input for the pair to generate a single bias value for the pair that is shared across the attention heads of all of the attention layers that apply functional interpolation.

As described above, the processes 200 and 300 can be performed as part of predicting an output for an input for which the desired output, i.e., the output that should be generated by the system for the input sequence, is not known.

The processes 200 and 300 can also be performed as part of processing inputs derived from a set of training data, i.e., inputs derived from a set of inputs for which the output that should be generated by the system is known, in order to train the attention neural network to determine trained values for the parameters of the attention neural network.

The system can repeatedly perform the processes 200 and 300 on inputs selected from a set of training data as part of a conventional machine learning training technique to train the attention layers and the output layer(s) of the neural network, e.g., a gradient descent with backpropagation training technique that uses a conventional optimizer, e.g., stochastic gradient descent, RMSprop, or Adam optimizer, to optimize an objective function that is appropriate for the task that the attention neural network is configured to perform.

During training, the system can incorporate any number of techniques to improve the speed, the effectiveness, or both of the training process. For example, the system can use dropout, label smoothing, or both to reduce overfitting. As another example, the system can perform the training using a distributed architecture that trains multiple instances of the attention neural network in parallel.

Moreover, the system can first pre-train some or all of the neural network on a large unsupervised data set through unsupervised learning, e.g., to minimize a BERT loss, a PEGASUS loss, a UL2 loss or other unsupervised loss, and then fine-tune the neural network on task-specific training data to optimize the objective function for the task.

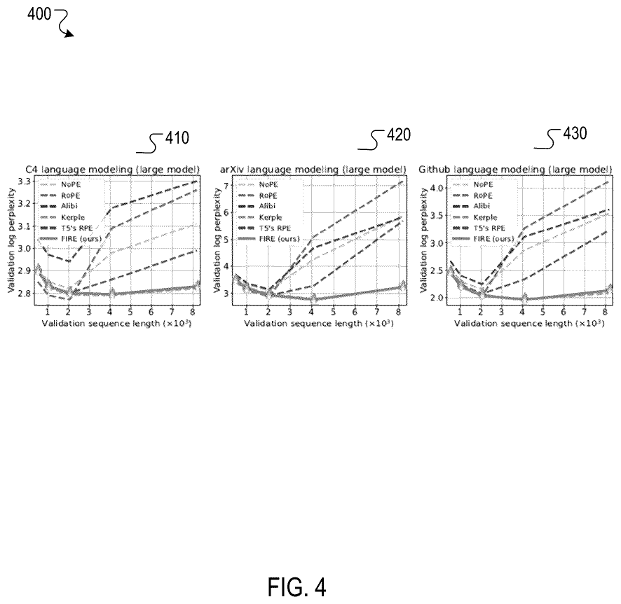

FIG. 4 shows an example 400 of the performance of the described techniques. In particular, FIG. 4 shows three plots 410, 420, and 430 that each show the performance on a corresponding data set of the described techniques (FIRE) relative to a technique (NoPE) that does not use positional encoding and four other positional encoding techniques. For each technique, the neural network is trained with a sequence length of 2048 tokens. As can be seen from the example 400, the described techniques significantly outperform the other techniques in terms of generalizing to longer sequences than were seen during training. In fact, the described techniques maintain high quality on sequences exceeding 8000 tokens, approximately 4 times longer than the sequences used for training.

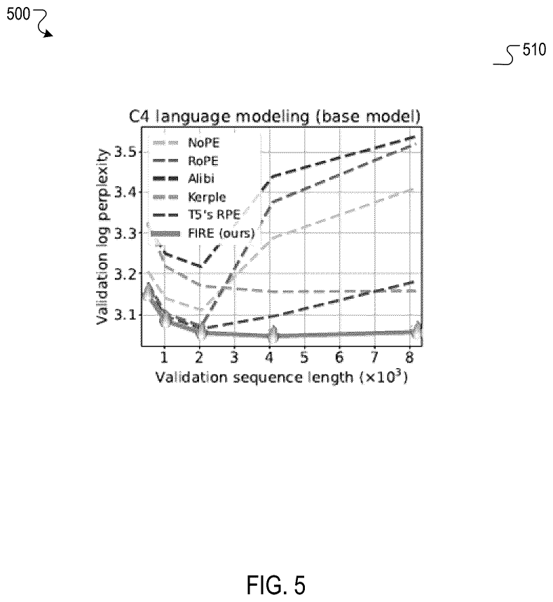

FIG. 5 shows another example 500 of the performance of the described techniques. In particular, FIG. 5 shows a plot 510 that shows the performance of the same techniques as in the example 400, but when used to train a smaller model, e.g., a “base” model vs a “large” model as used in the example 400. As can be seen from the example 500, the described techniques also outperform the other techniques when used with smaller models.

An “embedding,” as used in this specification is a vector of numeric values, e.g., floating point or other type of numeric values, that has a predetermined dimensionality, e.g., has a predetermined number of values.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
receiving a current input sequence having a respective input token at each of a plurality of input positions each having a respective index;
processing the current input sequence using an attention neural network having a plurality of attention layers to generate an output for the current input sequence, wherein each attention layer comprises one or more attention heads, and wherein the processing comprises, for each attention head of each of one or more of the attention layers:
determining a set of bias values that comprises a respective bias value for each of a plurality of pairs of indices, wherein each pair of indices comprises a respective first index and a respective second index, and wherein the respective bias value for each of the plurality of pairs of indices is generated by processing an input for the pair of indices that is based on (i) the respective first index in the pair and (ii) the respective second index in the pair using a corresponding attention bias generation neural network for the attention head;
determining a set of initial attention logits that comprises a respective attention logit for each of the pairs of indices from at least (i) a respective query for the attention head for the last token in the current input sequence and (ii) respective keys for the attention head for the tokens in the current input sequence;
generating final attention logits, comprising combining the set of initial attention logits with the set of bias values; and
applying the final attention logits to respective values for the attention head for the tokens in the current input sequence to generate an attention head output.

2. The method of claim 1, wherein for each attention head of each of the one or more attention layers, the corresponding attention bias generation neural network is a same neural network that is configured to output respective bias values for each of the attention heads.

3. The method of claim 1, wherein each attention layer of the one or more attention layers has a different corresponding attention bias generation neural network.

4. The method of claim 1, wherein each corresponding attention bias generation neural network has been trained jointly with the attention neural network.

5. The method of claim 1, wherein each corresponding attention bias generation neural network is a multi-layer perceptron (MLP).

6. The method of claim 1, wherein the input for the pair of indices is a difference between the respective second index and the respective first index divided by the respective second index.

7. The method of claim 1, wherein the input for the pair of indices is a a) a difference between (i) an output of a transformation function applied to the respective second index and (ii) an output of the transformation function applied to the respective first index divided by b) the output of the transformation function applied to the respective second index.

8. The method of claim 1, wherein the input for the pair of indices is a a) a difference between (i) an output of a transformation function applied to the respective second index and (ii) an output of the transformation function applied to the respective first index divided by b) an output of the transformation function applied to a maximum of iii) a scalar value or iv) the respective second index.

9. The method of claim 8, wherein the scalar value is learned jointly during the training of the attention neural network.

10. The method of claim 7, wherein the transformation function has one or more parameters that are learned jointly with the training of the attention neural network.

11. The method of claim 7, wherein the transformation function is a monotonically increasing transformation with a monotonically decreasing slope.

12. The method of claim 1, wherein:
the attention layer applies causal attention, and
the respective second index in each of the plurality of pairs is an index of the last token in the current input sequence.

13. The method of claim 12, wherein the output for the current output sequence is a prediction of a token that follows the last token in the current input sequence.

14. The method of claim 12, wherein the attention head output is an updated embedding for the last token in the current input sequence.

15. The method of claim 1, wherein:
the attention layer applies bi-directional attention, and
the plurality of pairs includes each possible pair of input indices in the current input sequence.

16. The method of claim 15, wherein the attention head output is a respective updated embedding for each token in the current input sequence.

17. The method of claim 1, wherein combining the set of initial attention logits with the set of bias values comprises:
determining a sum of the set of the initial attention logits with the set of bias values.

18. The method of claim 1, wherein the processing further comprises, when the attention layer includes multiple attention heads:
combining the attention head outputs to generate a final output for the attention layer.

19. The method of claim 1, wherein generating final attention logits comprises applying a softmax after combining the set of initial attention logits with the set of bias values.

20. A system comprising one or more computers and one or more storage devices storing instructions that when executed by the one or more computers cause the one or more computers to perform operations comprising:
receiving a current input sequence having a respective input token at each of a plurality of input positions each having a respective index;
processing the current input sequence using an attention neural network having a plurality of attention layers to generate an output for the current input sequence, wherein each attention layer comprises one or more attention heads, and wherein the processing comprises, for each attention head of each of one or more of the attention layers:
determining a set of bias values that comprises a respective bias value for each of a plurality of pairs of indices, wherein each pair of indices comprises a respective first index and a respective second index, and wherein the respective bias value for each of the plurality of pairs of indices is generated by processing an input for the pair of indices that is based on (i) the respective first index in the pair and (ii) the respective second index in the pair using a corresponding attention bias generation neural network for the attention head;
determining a set of initial attention logits that comprises a respective attention logit for each of the pairs of indices from at least (i) a respective query for the attention head for the last token in the current input sequence and (ii) respective keys for the attention head for the tokens in the current input sequence;
generating final attention logits, comprising combining the set of initial attention logits with the set of bias values; and
applying the final attention logits to respective values for the attention head for the tokens in the current input sequence to generate an attention head output.

21. One or more non-transitory computer-readable storage media storing instructions that when executed by one or more computers cause the one or more computers to perform operations comprising:
receiving a current input sequence having a respective input token at each of a plurality of input positions each having a respective index;
processing the current input sequence using an attention neural network having a plurality of attention layers to generate an output for the current input sequence, wherein each attention layer comprises one or more attention heads, and wherein the processing comprises, for each attention head of each of one or more of the attention layers:
determining a set of bias values that comprises a respective bias value for each of a plurality of pairs of indices, wherein each pair of indices comprises a respective first index and a respective second index, and wherein the respective bias value for each of the plurality of pairs of indices is generated by processing an input for the pair of indices that is based on (i) the respective first index in the pair and (ii) the respective second index in the pair using a corresponding attention bias generation neural network for the attention head;
determining a set of initial attention logits that comprises a respective attention logit for each of the pairs of indices from at least (i) a respective query for the attention head for the last token in the current input sequence and (ii) respective keys for the attention head for the tokens in the current input sequence;
generating final attention logits, comprising combining the set of initial attention logits with the set of bias values; and
applying the final attention logits to respective values for the attention head for the tokens in the current input sequence to generate an attention head output.
